(19) United States
(12) Patent Application Publication
(10) Pub. No.: US 2016/0202427 A1
(43) Pub. Date: Jul. 14, 2016

(54) OPTICAL COUPLER

(71) Applicant: 3M INNOVATIVE PROPERTIES COMPANY, Saint Paul, MN (US)

(72) Inventors: Terry L. Smith, Roseville, MN (US); Barry J. Koch, Florence, TX (US); Ding Wang, Austin, TX (US)

(21) Appl. No.: 14/914,963

(22) PCT Filed: Sep. 12, 2014
(86) PCT No.: PCT/US2014/055450

§ 371 Date: Feb. 26, 2016

Related U.S. Application Data
(60) Provisional application No. 61/878,433, filed on Sep. 16, 2013.

(51) Int. Cl. G02B 6/38; G02B 6/36; G02B 27/00; G02B 6/26

(52) U.S. Cl. CPC G02B 6/3801; G02B 6/262; G02B 6/3604; G02B 27/0025

(57) ABSTRACT

An optical assembly includes first (102) and second (103) housings configured to move relative to each other. The first housing includes an attachment area (124) configured to permanently attach an optical waveguide (122) and having a facet (634) that optically couples the optical waveguide to the first housing. The first housing further includes an first input/output surface (112) at a non-zero angle to the facet and a light redirecting member (638) optically coupled to change a direction and divergence of light between the facet and the first input/output surface. The second housing includes a second input/output surface (113) facing and optically coupled to the first input/output surface. The first and second input/output surfaces maintain an alignment along a light propagation direction therebetween through a range of motion between the first and second housings. The second housing includes a transmission path configured to convey signals optically received or transmitted via the second input/output surface.

### TECHNICAL FIELD

The present disclosure relates to optical couplers used to couple light between housings that move relative to one another.

### BACKGROUND

Optical fiber connectors can be used to connect optical fibers in a variety of applications including: telecommunications networks, local area networks, data center links, and for internal links in high performance computers. These connectors can be grouped into single fiber and multiple fiber designs and also grouped by the type of optical coupling employed. Optical coupling may be accomplished by both physical contact and non-contact methods. Physical contact methods include: direct contact, where the mating fiber tips are polished to a smooth finish and pressed together; index matched, wherein a compliant material with an index of refraction that is matched to the core of the fiber fills a small gap between the mated fibers' tips. With each of these contact methods, a small bit of dust or debris on the tip of the mated fibers can greatly increase the light loss. In non-contact methods the light passes through a small air gap between the two fiber tips. Many non-contact methods utilize expanded-beam coupling, where light exiting the core of one fiber is focused onto the core of another fiber using optical elements such as lenses or mirrors. In the region between the fiber cores, the illuminated area of the beam is larger than at the fiber core. In this region of larger illuminated area, the relative loss caused by small particles of dust or debris is reduced compared to the loss that would be caused by their presence at the fiber end, thus expanded beam coupling is more resistant to negative effects of dust and debris that is physical-contact coupling.

### SUMMARY

The present disclosure relates to optical couplers. In one aspect, an optical assembly includes first and second housings configured to move relative to each other. The first housing includes an attachment area configured to permanently attach an optical waveguide that extends outside the first housing. The attachment area includes a facet that optically couples the optical waveguide to the first housing. The first housing further includes an first input/output surface at a non-zero angle to the facet and a light redirecting member optically coupled to change a direction and divergence of light between the facet and the first input/output surface such that a first illumination area of the light at the facet is smaller than a second illumination area at the first input/output surface. The second housing includes a second input/output surface facing and optically coupled to the first input/output surface. The first and second input/output surfaces maintain an alignment along a light propagation direction therebetween through a range of motion between the first and second housings. The second housing includes a transmission path configured to convey outside the second housing signals optically received or transmitted via the second input/output surface.

In some configurations, the first and second housings may be configured to move linearly relative to each other along the light propagation direction, such than a linear movement changes a separation between the first and second input/output surfaces along the light propagation direction. In another configurations, the first and second housings may be configured to rotate relative to each other around the light propagation direction, such than a rotation does not change a separation between the first and second input/output surfaces along the light propagation direction. In yet other configurations, the first and second housings may be configured to rotate and translate relative to each other around and along the light propagation direction.

In one configuration, a portion of light propagating between the first and second input/output surfaces may be collimated. In such a case, the portion of light propagating between the first and second input/output surfaces may be collimated by the light redirecting member. In other configurations, optical coupling efficiency between the facet and the transmission path remains substantially the same through a range of movement of the first and second housings.

In a more particular embodiment, the transmission path of the second housing includes a second attachment area configured to permanently attach a second optical waveguide that extends outside the second housing. The attachment area includes a second facet that optically couples the optical waveguide to the second housing. The second facet is oriented at a second non-zero angle to the second input/output surface. In this case, the transmission path also includes a second light redirecting member optically coupled to change a second direction and second divergence of light between the second facet and the second input/output surface such that a third illumination area of the light at the second facet is smaller than a fourth illumination area at the second input/output surface. In this particular embodiment, the first and second housings may include duplicate parts, and/or the first and second housings may be symmetrical about a plane that is normal to the light propagation direction.

In another configuration, the transmission path of the second housing may include an optoelectronic transducer that converts between light and electronic signals. In such a case, the optoelectronic transducer may include a photodiode, laser and/or light-emitting diode. In other configurations, the light redirecting member may include a curved reflecting surface. In yet another configuration, the optical waveguide may include a channel waveguide fabricated from at least one of polymers, silicon, silicon dioxide, or silicon oxynitride.

In a more particular embodiment, the first housing may further included a second transmission path configured to convey second signals optically received from or transmitted to the first housing. The second signals may be used to determine a relative orientation between the first and second housings. In such a case, the second housing further includes a third transmission path configured to convey the second signals outside of the second housing. In this more particular embodiment, the second transmission path may include a second attachment area configured to permanently attach a second optical waveguide that extends outside the first housing. The second attachment area includes a second facet that optically couples the second optical waveguide to the first housing. The light redirecting member may be optically coupled to change a second direction and second divergence of light between the second facet and the first input/output surface. At least one of the second and third transmission paths may include a plurality of photo detectors, and the plurality of photo detectors may include at least one charge coupled array detector. The second transmission path may include a sensor facet on the first input/output surface, the sensor facet spaced away from the alignment axis.

In another embodiment, a method involves receiving light from a first optical waveguide at a first optical housing. The first optical waveguide extends out of and is permanently attached to a first attachment area of the first optical housing. The method involves expanding and redirecting the light out of the first optical housing along an alignment axis between the first optical housing and a second optical housing. The expanded light is received at an input surface of the second optical housing. The first and second optical members are aligned by a support member that facilitates relative motion therebetween while maintaining alignment along the alignment axis. A signal representative of the expanded light is conveyed outside of the second optical housing in response to receiving the expanded light at the input surface.

In more particular embodiments of the method, expanding the light out of the first optical housing may involve collimating the light. The first and second optical housings may be configured to move linearly relative to each other along the alignment axis, such than a linear movement changes a separation between the first and second input/output surfaces along the alignment axis. The first and second optical housings may be configured to rotate relative to each other around the alignment axis, such than a rotation does not change a separation between the first and second input/output surfaces along the alignment axis.

In more particular embodiments of the method, an optical coupling efficiency between the first optical waveguide and a transmission path that receives the expanded light remains substantially the same through a range of movement of the first and second optical housings. In one variation, conveying the signal representative of the expanded light t outside of the second optical housing involves redirecting and focusing the expanded light to a second optical waveguide that extends out of and is permanently attached to a second attachment area of the second optical housing. In another variation, conveying the signal representative of the expanded light outside of the second optical housing may involve converting the expanded light to an electronic signal.

In other variations, expanding and redirecting the light out of the first optical housing may involve reflecting the light off of a curved surface, such as a parabolic surface. In another variation, the method further involves propagating a second light beam out of the first optical housing parallel to the alignment axis, receiving at least part of the second light beam at the second optical housing, and determining a relative orientation between the first and second optical housings based on receiving the at least part of the second light beam. In such a case, the second light beam may be spaced apart from the expanded light. This variation may further involve receiving the second light beam from a second optical waveguide at the first optical housing, the second optical waveguide extending out of and permanently attached to a second attachment area of the first optical housing. The second light beam may be expanded and redirected out of the first optical housing parallel to the alignment axis. This variation may further involve splitting the light from the first optical waveguide to form the second light beam, and expanding and redirecting the second light beam out of the first optical housing along the alignment axis.

In one variation, determining the relative orientation involves determining a relative rotation and/or a separation distance between the first and second optical housings. In one configuration, the second light beam is co-located with the expanded light, and the second light beam has different optical characteristics from the expanded light. The different optical characteristics may include at least one of wavelength and polarization. The second light beam may have a larger divergence than the expanded light, and wherein determining the relative orientation comprises sensing the second light beam at a second optical receiver that is spaced apart from an optical receiver that detects an intensity of the expanded light.

In another embodiment, an optical connector includes a first optical member having a first attachment area configured to permanently attach a first optical waveguide that extends along a first plane outside of the first optical member. The first attachment area includes a first facet that optically couples light from the first optical waveguide to the first optical member. The first optical member also includes a first curved reflector having a first focal region proximate the first facet. The first curved reflector reflecting the light in a first direction normal to the first plane. The optical connector includes a second optical member that is coupled to the first optical member. The second optical member includes a second curved reflector having a second focal region. The second curved reflector receives the reflected light and re-reflects the light at second direction parallel to the first plane and towards the second focal region. The second optical member also includes a second attachment area configured to permanently attach a second optical waveguide that extends parallel to the first plane outside of the second optical member. The second attachment area includes a second facet proximate the second focal region that optically couples the second optical waveguide to the second optical member.

In one configuration, the first curved reflector causes an aberration in the reflected light, and the second curved reflector at least partially corrects the aberration in the re-reflected light. The first and second curved reflectors may include parabolic reflectors, and/or the first and second optical members may be parts of a unitary structure or may be separable. The first and second optical members may include mating features that facilitate relative rotation between the first and second optical members about an axis normal to the first plane.

In another configuration, the first optical member may further include a lens (e.g., a gradient-index lens) that expands the light from the first optical waveguide to the first curved reflector. The second optical member may further include a lens that focuses the light to the second optical waveguide. At least one of the first and second optical waveguides may include an optical fiber and/or a channel waveguide fabricated from at least one of polymers, silicon, silicon dioxide, or silicon oxynitride.

In other configurations, the first and second optical waveguides may be aligned with one another, each propagating transmitted light in a direction opposite the other. In another configuration, the first and second optical waveguides may be aligned with one another, both propagating transmitted light in a common direction. In yet another configuration, the first and second optical waveguides are not aligned with one another, the first optical carrier propagating light at an angle to a propagation direction of the second optical waveguide.

In another embodiment, a method involves receiving light at a first optical member via a first facet from a first optical waveguide that extends along a first plane outside of the first optical member. The waveguide is permanently attached to the first optical member. The method further involves reflecting the light in a first direction normal to the first plane via a first curved reflector of the first optical member. The reflected light is received at a second curved reflector of a second optical member. The second optical member is coupled to the first optical member, and the second curved reflector re-reflects the light at second direction parallel to the first plane and towards a second focal region. The re-reflected light is received at a second facet at the second focal region, and the re-reflected light is directed from the second facet to a second optical waveguide that extends parallel to the first plane outside of the second optical member via a second attachment area configured to permanently attach the second optical waveguide.

In more particular embodiments, the first curved reflector causes an aberration in the reflected light, and the second curved reflector at least partially corrects the aberration in the re-reflected light. The first and second optical waveguides may be aligned with one another, each propagating transmitted light in a direction opposite the other or in a common direction. The first and second optical waveguides may not be aligned with one another, such that the first optical carrier propagates light at an angle to a propagation direction of the second optical waveguide.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1 is an isometric view of an embodiment of a hinged optical assembly;

FIG. 2 is an isometric view of an embodiment of first and second housings assemblies of the optical assembly shown in FIG. 1;

FIG. 3 is a cross-sectional view of the hinged optical assembly of FIG. 1;

FIGS. 4 and 5 are schematic views of apparatuses using hinged optical assemblies according to example embodiments;

FIG. 6 is a cutaway view of first and second housing assemblies shown in FIG. 2;

FIG. 7 is a cutaway view of first and second housings according to another example embodiment;

FIG. 8 is a cutaway view of first and second housings according to another example embodiment;

FIG. 9 is a schematic view of an optical housing according to an example embodiment;

FIG. 10 is an isometric view of the back of the optical housing shown in FIG. 9;

FIGS. 11 and 11A are schematic views of housings according to other example embodiments;

FIG. 12 is a cutaway view of first and second housings according to another example embodiment;

FIG. 13 is a cutaway view of first and second housings according to another example embodiment;

FIG. 14 is a schematic view of an optical connector according to an example embodiment;

FIG. 15 is a cross-sectional view of an optical connector assembly according to another example embodiment;

FIG. 16 is a cross-sectional view of an optical connector assembly according to another example embodiment;

FIG. 17 is a plan view of an optical connector assembly according to another example embodiment;

FIG. 18 is a cross-sectional view of an optical connector assembly according to another example embodiment;

FIG. 19 is a flowchart showing a method according to an example embodiment;

FIG. 20 is a graph showing efficiency gains due to correction of aberrations in an optical connector according to an example embodiment;

FIG. 21 is a graph showing rotation-dependent coupling efficiency of an optical connector according to an example embodiment.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying drawings that form a part hereof and in which are shown by way of illustration. It is to be understood that other embodiments are contemplated and may be made without departing from the scope or spirit of the present disclosure. The following detailed description, therefore, is not to be taken in a limiting sense.

The present disclosure is related generally to optical connectors that facilitate connections (e.g., data connections via optical waveguides) between two moving parts. Optical waveguides can be used in a wide variety of applications. For example, optical carriers can carry information over long distances without significant signal loss and without being significantly impacted by electromagnetic interference. As such, optics are used in long-distance data transmission.

Optical data transmission has another advantage pertaining to moving parts. Because optical signals can be transmitted through the air, optical connectors can be configured to transmit data between parts that move relative to one another without requiring direct physical contact between the parts. This allows such connectors to rotate indefinitely without inducing wear from friction or bending.

For example, devices such as laptop computers may have a display built into a cover that is connected to a keyboard base section by a hinge. A flexible electrical cable may be disposed through the hinge to provide power and data to the display. Flexing of the cable due to repeated opening and closing of the cover may be cause failure in the conductors and/or insulators of an electrical cable. Also, the copper cable passing through the hinge may be a source of electromagnetic emission or interference, and at high bit rates, may experience significant power loss resulting in increased system power consumption. As will be shown in greater detail below, an optical device may provide a data connection through a hinge or similar member without flexing of signal carrying components.

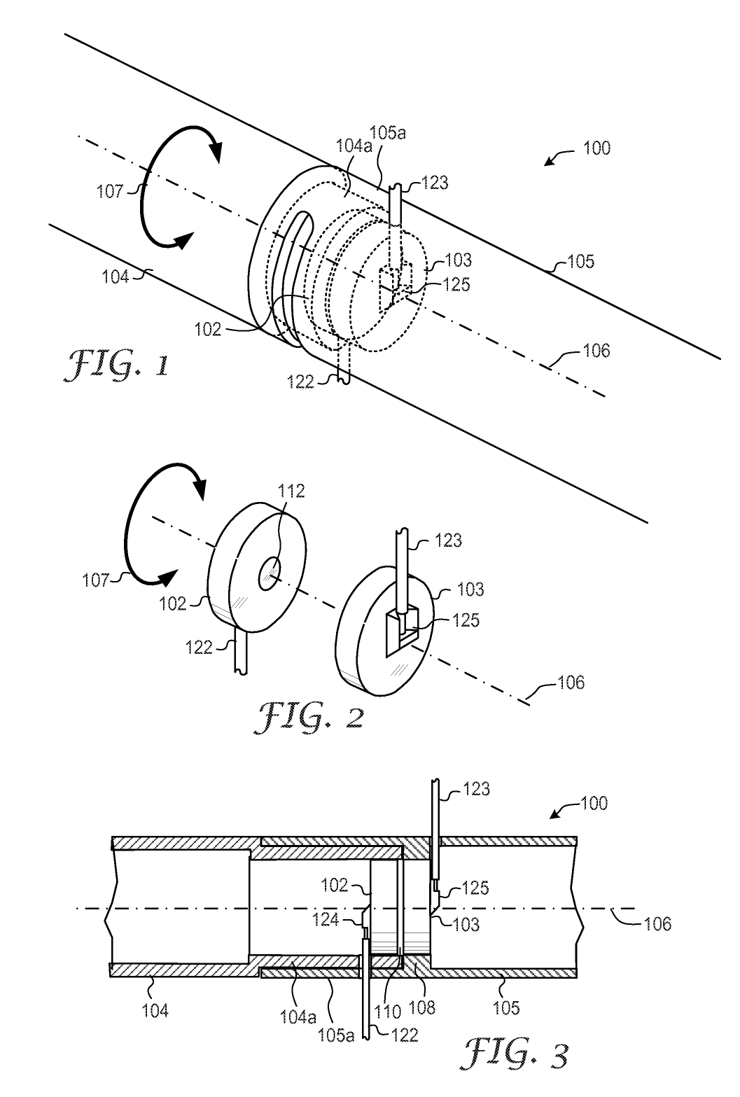

In reference now to FIGS. 1-3, a hinged optical assembly 100 according to an example embodiment is shown. The hinged optical assembly 100 is shown in a perspective view in FIG. 1 and in a cross-sectional view in FIG. 3. The optical assembly 100 includes first and second housings 102, 103 enclosed in first and second hinge members 104, 105. While the first and second hinged members 104, 105 may considered part of the hinged optical assembly 100, for purposes of this discussion, these are considered optional. For example, the first and second housings 102, 103 may be considered an optical coupling assembly that does not require the illustrated hinge structure. Details of the first and second housings 102, 103 can be seen in the exploded view of FIG. 2.

The first housing 102 is mounted in a narrowed end 104a of the first hinge member 104. The second housing 103 is located in the end 105a of the second hinge member 105 via a mounting flange 108, seen in FIG. 3. The narrowed end 104a of the first hinge member 104 is disposed concentrically in an end 105a of the second hinge member 105 so that the hinge members 104, 105 are at least capable of rotating relative to one another about an alignment axis 106, as indicated by arrow 107 in FIGS. 1 and 2. This also causes the first and second housings 102, 103 to be rotated relative to one another as indicated by the arrow 107.

The concentric alignment of the first and second hinge members 104, 105 causes the first and second housings 102, 103 to be concentrically aligned with one another along the alignment axis 106. The first and second housings 102 are separated by a gap 110 seen in FIG. 3. The gap 110 may be filled with air, or by fluid, gel, or other material that matches refractive indexes of light transmitting/receiving surfaces of the first and second housings 102, 103. The gap 110 may be optional, e.g., such that the transmitting/receiving surfaces (e.g., output side 112 in FIG. 2) of the first and second housings 102, 103 are at least in partial contact with one another. The first and second hinge housings 102, 103 are able to rotate relative to one another about the alignment axis 106 such that rotation does not change a separation (e.g., gap 110) between the transmitting/receiving surfaces along the alignment axis 106.

Generally, the first and second housings 102, 103 optically couple a first optical waveguide 122 and a second optical waveguide 123. Generally, the term optical coupling refers to transmission or propagation of light from one optical component to another. This may at least involve directing light, e.g., by reflection, refraction and/or positioning of elements. Unless otherwise stated, optical coupling is not intended to describe a direction of transmission or propagation. It will be understood that apparatuses described herein may facilitate optical coupling in multiple directions, and discussion of a particular transmission direction is for purposes of convenience and not of limitation.

For purposes of the discussion of FIGS. 1-3, the coupling of light between first and second housing 102, 103 will be described as light being sent from the first optical waveguide 122 to the second optical waveguide 123. The first and second optical waveguides 122, 123 may be any combination of optical fibers, channel waveguides, or other optical carriers known in the art. For example, the optical waveguides 122, 123 may include one or more channel waveguides fabricated from at least one of polymers, silicon, silicon dioxide, or silicon oxynitride.

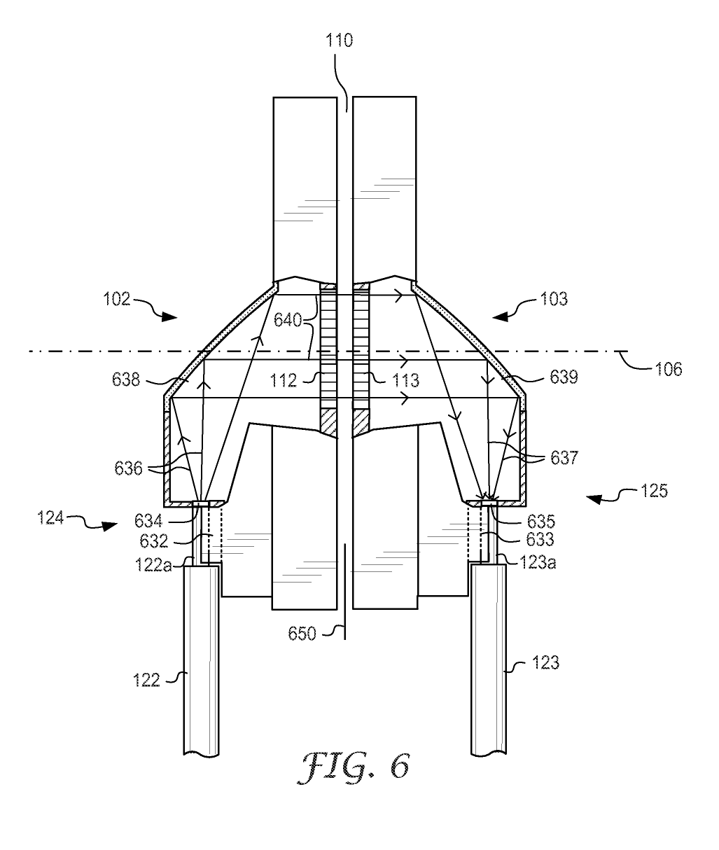

The first optical waveguide 122 may be received in and permanently attached to a first attachment area 124 (see FIG. 3 and FIG. 6) of the first housing 102. The first optical waveguide 122 extends outside the first housing 102 and receives light that is input to the optical assembly 100. The second optical waveguide 123 is attached to a second attachment area 125 and extends outside the second housing 103. The second optical waveguide 123 is configured to receive light output from the hinged optical assembly 100.

The first and second housings 102, 103 may be configured as an expanded beam coupler. This type of coupler allows the light beam to exit the first optical waveguide 122 at a first divergence, where it is redirected within the first housing 102 where the first divergence is changed as well as a direction of the light beam. The light exits the first output side 112 at a second divergence, e.g., such that the light exiting the first output side 112 has a greater illumination area than the light exiting the first optical waveguide 122.

Generally, the term “illumination area” refers to an outline of a light beam intersecting a plane. The illumination area may be characterized by a beam diameter, e.g., in configurations where the light beam has a circular profile. Generally, increasing the divergence of light beam propagating from a first to a second location increases the illumination area at the second location relative to the first location, and as such the light beam may be referred to as an expanded beam. However, this does not require that an expanded beam have a positive divergence. For example, an expanded beam may have a negative divergence or zero divergence (e.g., be collimated), so long as the light beam had a smaller illumination area at a previous traversal point along the path.

The second housing 103 receives the expanded light, and may focus the light back to its original diameter on the tip of the second optical waveguide. The optical paths within the first and second housings 102, 103 are described in greater detail below in reference to FIG. 6. Generally, the expansion of the light between the first and second housings 102, 103 causes the optical assembly 100 to be less sensitive to dust and other forms of contamination that may be present in the gap region 110 than if the light were directly coupled at an illumination area corresponding to that of the optical waveguides 122, 123.

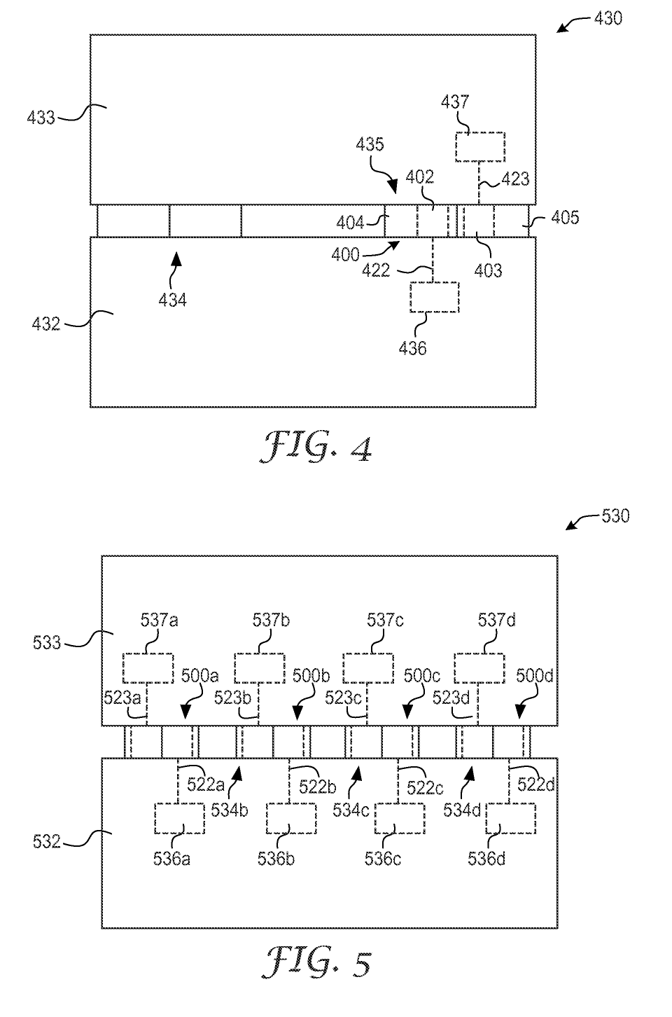

In FIGS. 4 and 5, a schematic view illustrates example implementations of an apparatus using one or more hinged optical assemblies. In FIG. 4, an apparatus 430 (e.g., computer, mobile device, consumer electronics device, etc.) includes first and second hinged portions 432, 433. If the apparatus 430 is configured as a laptop computer for example, the second hinged portion 433 may include a display, and the first hinged portion 432 may include motherboard, keyboard, battery, etc. The first and second hinged portions 432, 433 are mechanically coupled via hinges 434, 435.

Hinge 435 includes an optical coupling assembly 400, with first and second housings 402, 403 coupled to first and second optical waveguides 422, 423. The first and second optical waveguides 422, 423 are coupled to respective first and second optoelectronic modules 436, 437 of the first and second hinged portions 432, 433. The first and second optoelectronic modules 436, 437 may include optoelectronic devices such as lasers, light-emitting diodes (LEDs), photodiodes, photovoltaic cells, etc. The first and second optoelectonics modules 436, 437 may also include optical devices such as prisms, mirrors, polarizers, luminescent display elements (e.g., a glowing logo or status indicator), waveguides, etc. For example, one of the modules 436, 437 may include a passive illuminated element (e.g., decorative element, display, indicator, etc.) that receives light from the other module 436, 437 via the optical coupling assembly 400. The first and second optoelectronic modules 436, 437 may also include purely electrical devices as known in the art, e.g., receivers, transmitters, amplifiers, laser drivers, etc.

The first and second housings 402, 403 may be configured similarly to housings 102, 103 shown in FIGS. 1-3. The first and second housings 402, 403 may alternatively be configured as described in other embodiments hereinbelow, e.g., with one or more non-right angled waveguide couplers, optoelectronic module with light emitter or detector, having position-sensing elements, etc. Generally, the first and second housings 402, 403 facilitate coupling signals (e.g., optical and or electrical) of the first and second optical devices 436, 437 through the hinge 435 via a non-contact or sliding contact interface that is resistant to wear, contaminants and electro-magnetic interference.

In FIG. 5, an apparatus 530 (e.g., computer, mobile device, consumer electronics device, etc.) includes first and second hinged portions 532, 533. If the apparatus 530 is configured as a laptop computer for example, the second hinged portion 533 may include a display, and the first hinged portion 532 may include motherboard, keyboard, battery, etc. The first and second hinged portions 532, 533 are mechanically coupled via hinges 534a-d. Each of the hinges 534a-d includes a respective optical coupling assembly 500a-d, with first and second housings coupled to first and second optical waveguides 522a-d, 523a-d. The first and second optical waveguides 522a-d, 523a-d are coupled to respective first and second optoelectronic modules 536a-d, 537a-d of the first and second housings 532, 533. The first and second optoelectronic modules 536a-d, 537a-d may be configured similarly to the optoelectronic modules 436, 437 shown and described in FIG. 4.

The optical coupling assemblies 500a-d may be configured similarly to optical assembly 100 shown in FIGS. 1 and 3. One or more of the optical coupling assemblies 500a-d may alternatively configured as described in other embodiments hereinbelow, e.g., with one or more non-right angled waveguide couplers, optoelectronic module with light emitter or detector, having position sensing elements, etc. Generally, optical coupling assemblies 500a-d facilitate signal-coupling between the first and second optoelectronic modules 536a-d, 537a-d through the hinges 534a-d via a non-contact or sliding contact interface that is resistant to wear, contaminants and electro-magnetic interference.

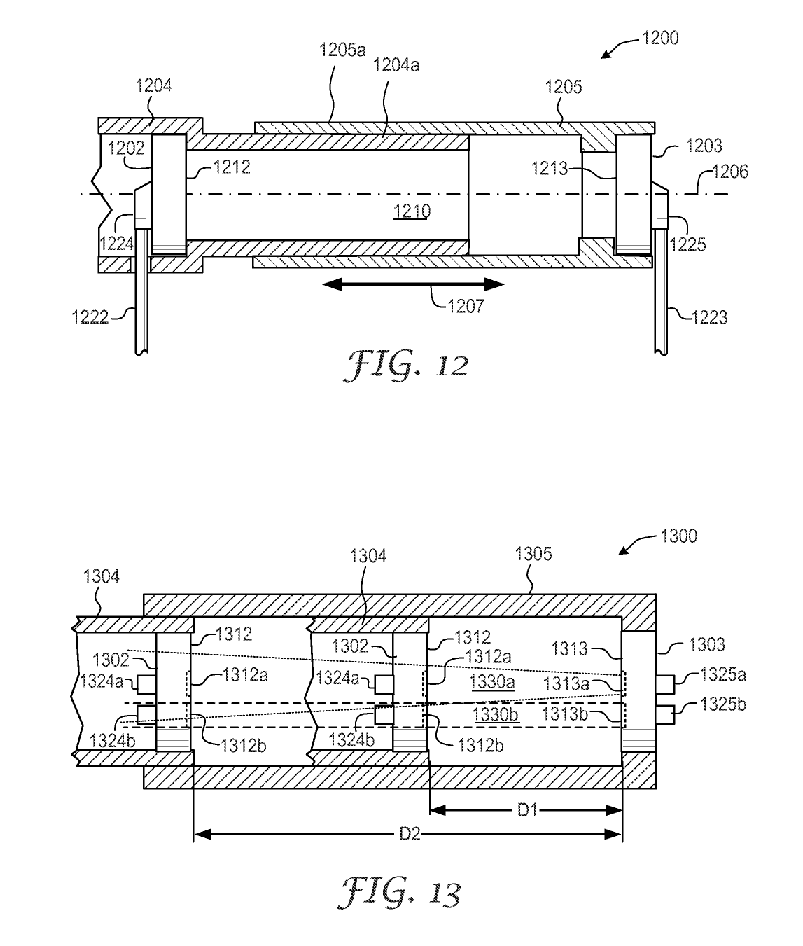

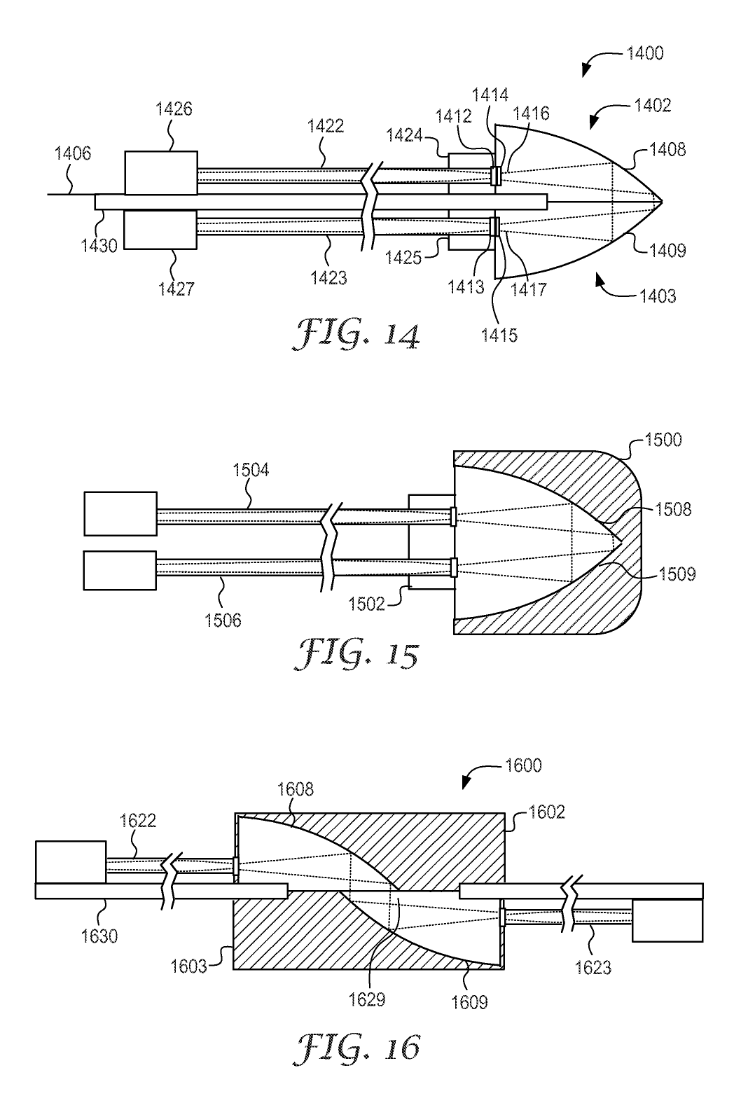

It will be understood that the optical housings described herein may be used in other applications that can benefit from non-contact signal coupling. For example, continuously rotating parts driven by a motor or the like may use similar optical housings to couple signals between a rotating part and a non-rotating part. The signals may include light used to illuminate passive optical components (e.g., indicators), light modulated with analog or digital signals used with active or passive components, light used to provide power (e.g., to photovoltaic cells), etc. The optical housings may also be used in applications where parts move linearly to one another (e.g., telescope), as will be described in greater detail below (see, e.g., FIGS. 12 and 13).

In reference now to FIG. 6, a cross-sectional view shows additional details of first and second housings 102, 103 according to example embodiments. The first and second optical waveguides 122, 123 are coupled at respective first and second attachment areas 124, 125. The attachment areas 124, 125 may permanently attach the first and second optical waveguides 122, 123 to the first and second housings 102, 103. As seen in this view, optical waveguides 122, 123 have buffer material stripped away at the terminating ends, and the bare cladding layers of the waveguides 122a, 123a are disposed in alignment channels 632, 633, e.g. V-grooves. The terminating ends of the first and second optical waveguides 122, 123 may be coated after attachment with a bonding/sealing material (not shown) that provides mechanical strength, acts as buffer for exposed portions of the waveguide claddings 122a, 123a, seals from contaminants, etc.

Terminating ends of the first and second optical waveguides 122, 123 are placed next to facets 634, 635 of the respective housings 102, 103. The facets 634, 635 optically couple the optical waveguides 122, 123 to the first and second housings 102, 103. The facets 634, 635 are at non-zero angles to input/output surfaces 112, 113. The facets 634, 635 may be configured as either input or output facets depending on the direction of light traversal though the housings 102, 103. In the illustration, facet 634 is shown as an input facet due to input light 636 exiting first optical waveguide 122 and facet 635 is an output facet due to output light 637 entering second optical waveguide 123. The illustrated arrangement may be configured such that light traverses different directions at different times, and so input facets may also be output facets at different times, and vice versa.

The input light 636 has a first divergence, e.g., a positive divergence from the input facet 634 as shown here, that is, the illuminated area of the beam increases as the light propagates away from the input facet. The first divergence may occur due to the numerical aperture of the waveguide, or due to the shape of an exit end of the first optical waveguide 122, or the first divergence may be shaped via an optical component such as a lens that is integrated with or separate from input facet 634. A first light redirecting member 638 receives light from the first input facet 634 in an input direction normal to the input facet 634, which in this example is at a right angle to alignment axis 106. The first light redirecting member 638 redirects the received light in a different direction, in this case a direction along the alignment axis 106. Generally, light propagates between the housings 102, 103 along the alignment axis 106, and so the alignment axis may define a propagation direction therebetween.

The first light redirecting member 638 is configured to change the first divergence of the reflected light, e.g., light redirected by the first light redirecting side 638 has a second divergence different than the divergence of the input light 636. For example, the first light redirecting member 638 may be configured as a collimating mirror, e.g., parabolic collimator. As such, the divergence of the light is decreased by the first light redirecting member 638, as it goes from a positive divergence between the input facet 634 and the first light redirecting member 638 to a zero divergence between the first light redirecting member 638 and first output surface 112. An illumination area of the light at the facet 634 is smaller than a second illumination area at the first output surface 112, and so the first housing has expanded the light beam between the facet 634 and first output surface 112.

The first output surface 112 of the first optical housing 102 receives expanded light 640 from the first light redirecting side 638 in output direction along the alignment axis 106. The expanded light 640 exits through the first output side 112 and enters through an input side 113 of the second optical housing 103 along the alignment axis. A second light redirecting side 639 receives the expanded light 640 from the input side 113 and redirects the light in an output direction, which in this example is at a right angle to alignment axis 106. The second light redirecting side 639 causes a change in divergence of the redirected light, which is seen here by the negative divergence (e.g., focusing) of the output light 637 on the output facet 635. The output light 637 is directed through the output facet to core 123a of optical waveguide 123.

It should be noted that due to the symmetry between the housings 102, 103 about a plane 650, the housings 102, 103 may be made from a single design. The housings 102, 103 may also be considered hermaphroditic optical couplers, e.g., neither male nor female. As such, it is possible to use duplicate manufactured parts for both housings 102. Using the same part for both sides facilitates reducing parts counts in the end assembly, and may also lead to cost reduction in tooling. Further, identical or symmetric parts can help reduce errors in assembly, such as parts being placed in a wrong orientation to one another. It should be noted that other optical coupler embodiments described below may also use a single part for both housings, as will be apparent to one or ordinary skill in the art by inspection of the figures.

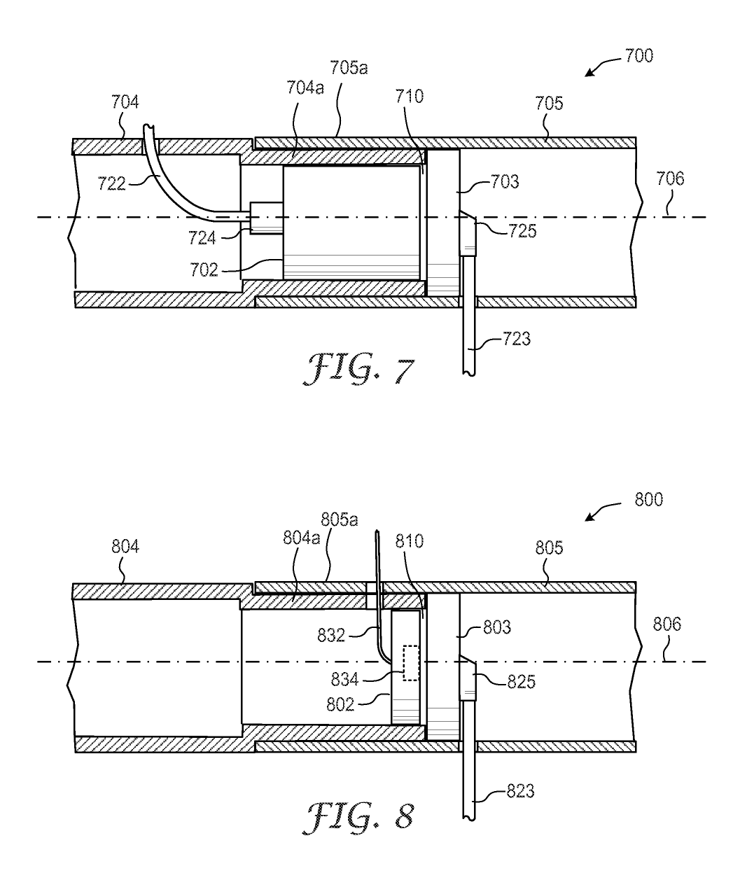

In reference now to FIG. 7, a cross-section view shows a hinged optical assembly 700 according to another example embodiment. The optical assembly 700 includes housings 702, 703 enclosed in first and second hinge members 704, 705. The housings 702, 703 are at least part of the optical coupling assembly, and the illustrated hinge structure may be optional. The housing 702 is mounted in a narrowed end 704a of the first hinge member 704. The housing 703 is located in the end 705a of the second hinge member 705. The narrowed end 704a of the first hinge member 704 is disposed concentrically in an end 705a of the second hinge member 705 so that the hinge members 704, 705 are at least capable of rotating relative to one another about an alignment axis 706. This also causes the housings 702, 703 to be rotated relative to one another.

The concentric alignment of the first and second hinge members 704, 705 causes the housings 702, 703 to be concentrically aligned with one another along the alignment axis 706, and this alignment is maintained during rotation of the housings 702, 703. The housings 702 are separated by a gap 710. The gap 710 may be filled with air, or by fluid, gel, or other material that matches refractive indexes of light transmitting/receiving surfaces of the housings 702, 703. The gap 710 may be optional, e.g., such that the transmitting/receiving surfaces of the housings 702, 703 facing the gap 710 are at least in partial contact with one another. The first and second hinge housings 702, 703 are able to rotate relative to one another about the alignment axis 706 such that rotation does not change a separation (e.g., gap 710) between the transmitting/receiving surfaces along the alignment axis 706.

Generally, the housings 702, 703 couple light between a first optical waveguide 722 and a second optical waveguide 723. For purposes of this discussion, the coupling of light will be described as light being received via the first optical waveguide 722 and being sent to the second optical waveguide 723. It will be understood that the optical assembly 700 may transmit light in either direction, and discussion of a particular transmission direction is for purposes of convenience and not of limitation.

The first and second optical waveguides 722, 723 may be any combination of optical fibers, polymer waveguides, or other optical carriers described herein or known in the art. The first optical waveguide 722 is received in and permanently attached to an attachment area 724 of the housing 702. The first optical waveguide 722 extends outside the housing 702 and receives light that is input to the optical assembly 700. The second optical waveguide 723 is attached to attachment area 725 and extends outside the housing 703. The second optical waveguide 723 is configured to output light from the hinged optical assembly 700.

One or both of the housings 702, 703 may be configured as expanded beam couplers. The housing 702 is a straight-through housing, such that light may be transmitted along the light propagation direction (e.g., along alignment axis 706) without deflection. The divergence of the light exiting the housing 702 may be changed via a lens, such as a gradient-index (GRIN) lens. Generally, a GRIN lens is formed by layering materials having different indices of refraction such that divergence of light passing through the lens can be changed without relying on curved outer surfaces. Other types of divergence altering devices may be used instead of a GRIN lens, such as a convex lens, concave lens, mirrors, etc. The light exits an output side of the housing 702 near gap 710 such that the light has a greater illumination area than the light exiting the first optical waveguide 722. If the housing 702 is used in the other direction, e.g., as an optical receiver, the lens or other optical device causes an opposite divergence of the light so that the light is focused onto the first optical waveguide 722.

The housing 703 may be configured as shown and described for housings 102, 103 in FIG. 6. Generally, the housing 703 uses a light redirecting member, e.g., curved reflector, collimating mirror, etc., that redirects the light from the light propagation direction along the alignment axis 706 to an angle corresponding to the attachment of the second optical waveguide 723. The light redirecting member of the housing is also optically coupled to change a direction and divergence of light at the input surface near gap 710 such that an illumination area of the light at the second optical waveguide 723 is smaller than a second illumination area at the input surface.

In reference now to FIG. 8, a cross-section view shows a hinged optical assembly 800 according to another example embodiment. The optical assembly 800 includes housings 802, 803 enclosed in first and second hinge members 804, 805. The housings 802, 803 are at least part of the optical coupling assembly, and the illustrated hinge structure may be optional. The housing 802 is mounted in a narrowed end 804a of the first hinge member 804. The housing 803 is located in the end 805a of the second hinge member 805. The narrowed end 804a of the first hinge member 804 is disposed concentrically in an end 805a of the second hinge member 805 so that the hinge members 804, 805 are at least capable of rotating relative to one another about an alignment axis 806. This also causes the housings 802, 803 to be rotated relative to one another.

The concentric alignment of the first and second hinge members 804, 805 causes the housings 802, 803 to be concentrically aligned with one another along the alignment axis 806, and this alignment is maintained during rotation of the housings 802, 803. The housings 802 are separated by a gap 810. The gap 810 may be filled with air, or by fluid, gel, or other material that matches refractive indexes of light transmitting/receiving surfaces of the housings 802, 803. The gap 810 may be optional, e.g., such that the transmitting/receiving surfaces of the housings 802, 803 facing the gap 810 are at least in partial contact with one another. The first and second hinge housings 802, 803 are able to rotate relative to one another about the alignment axis 806 such that rotation does not change a separation (e.g., gap 810) between the transmitting/receiving surfaces along the alignment axis 806.

Generally, the housings 802, 803 couple signals between an electrical conductor 832 and an optical waveguide 823. For purposes of this discussion, the coupling of light will be described as light generated via an optical transducer 834 (e.g., laser, LED) in the housing 802 and being sent to the optical waveguide 823. It will be understood that the optical assembly 800 may transmit light in either direction, and discussion of a particular transmission direction is for purposes of convenience and not of limitation. For example the optical transducer 834 may include a photodetector or the like instead of or in addition to a light-generating transducer, such that the housing 802 may act as an optical transmitter and/or optical receiver.

The optical waveguide 823 may include optical fibers or other types of waveguides as described elsewhere herein. The optical waveguide 823 is attached to an attachment area 825 and extends outside the housing 803. The conductor 832 may include insulated wire, flex circuit, ribbon cable, coaxial cable, TwinAx cable, etc., and may couple directly to the housing 802 (e.g., crimp, solder) or via a removable connector.

One or both of the housings 802, 803 may be configured as expanded beam couplers. The housing 802 may include lenses or other optical components between the transducer 834 and an input/output surface that faces the gap 810. The housing 803 may be configured as shown and described for housings 102, 103 in FIG. 6. Generally, the housing 803 uses a light reflecting member optically coupled to change a direction and divergence of light between the optical waveguide 823 and an input/output surface near the gap 810.

In embodiments shown above that where light is reflected between curved reflecting surfaces in different housings (e.g., light redirecting members 638, 639), coupling efficiency may change based on rotation between the housing, e.g., where the reflecting surfaces are paraboloid elements. This change in coupling efficiency may be used to sense rotation angle and/or rate between housings. Other features may be included in the respective light paths (e.g., polarizers, waveguides) that cause changes in other optical properties, such as polarization, waveguide mode profile, intensity, etc.

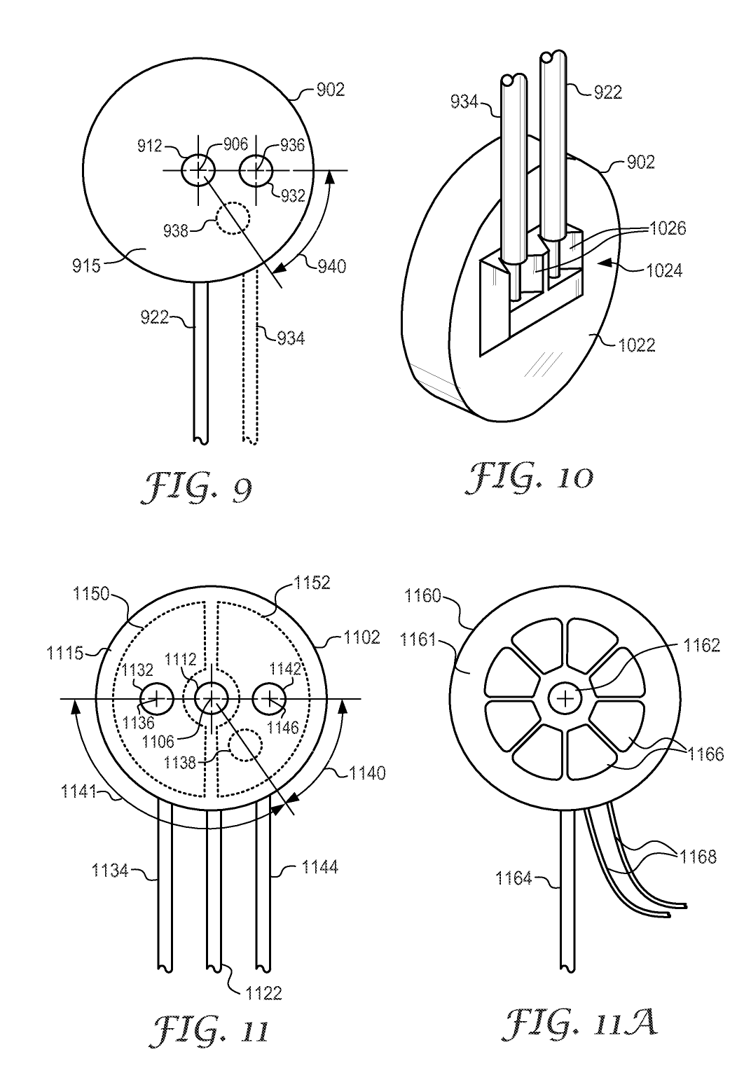

In other configurations, a dedicated light path may be used to detect relative orientation. While the illustrated hinged optical couplers include a single light path, e.g., aligned with an axis of rotation, such couplers may include multiple light paths. Light paths that are not aligned with a rotation axis may only propagate light between housings at certain rotation angles, and this conditional propagation can be used for location sensing. In FIG. 9, a schematic diagram illustrates a housing 902 with multiple light paths according to an example embodiment. The housing 902 may be configured with internal light redirecting members similar to housings 102, 103 shown in FIG. 6. The housing 902 may also use a straight through light path, such as housing 702 in FIG. 7. The multiple light path features described for housing 902 need not depend on any particular means used to couple optical waveguides to the housing 902, or in how or whether the housing changes divergence of light passing through the housing 902.

The housing 902 includes a first facet 912 on an input/output surface 915. The first facet 912 is optically coupled to a first optical waveguide 922. The first facet 912 and first optical waveguide 922 may be configured as optical receivers and/or optical transmitters. The first facet 912 is aligned with an alignment axis 906. The housing 902 is configured to rotate about the alignment axis 906. A second housing (not shown) that has an input/output surface facing input/output surface 915 of the housing 902 will have a corresponding facet also aligned with the alignment axis 906. This alignment of input/output surface facets along the alignment axis 906 allows for a range of relative rotation angles between the housings with minimal losses in light transmission therebetween. Further, the alignment of input/output surface facets ensures an optical coupling efficiency between the housings remains substantially the same through a range of movement of the housings.

The housing 902 includes a sensor facet 932 on the input/output surface 915. The sensor facet 932 may be optically coupled to a sensor optical waveguide 934. In alternate configurations, light received from the first optical waveguide 922 may be split and delivered to both facets 912, 932, in which case a sensor optical waveguide 934 would not be needed. The sensor facet 932 and sensor optical waveguide 934 (if used) may be configured as optical receivers and/or optical transmitters. The sensor facet 932 is aligned with an offset axis 936 that is spaced apart from the alignment axis 906. A corresponding facet of a mating housing, generally indicated by circle 938, may be offset from the sensor facet 932 by a rotation angle 940. If the rotation angle 940 is zero, most or all light originating from or targeted to optical waveguide will be transmitted between the sensor facet 932 and the corresponding facet 938. The light will be partially or fully blocked for non-zero values of the angle 940. In this way, an optical receiving element coupled to either sensor facet 932 or corresponding facet 938 (depending on which direction the light propagates) can detect at least an approximate zero value of angle 940 if only one corresponding facet 938 is used, and possibly other angles of more corresponding facets are used. For example, a mating housing can include a plurality of facets arranged concentrically around the alignment axis 906 to increase resolution of angle 940 (see FIGS. 11 and 11A).

In FIG. 10, a perspective view illustrates additional details of the optical housing 902 shown in FIG. 9. An input side 1022 of the optical housing 902 includes an attachment area 1024. The attachment area 1024 includes V-grooves 1026 that hold stripped ends of the first optical waveguide 922 and sensor optical waveguide 934. The spacing of the V-grooves 1026 may be determined by a desired separation between first facet 912 and sensor facet 932 on the input/output surface 915. The spacing of the V-grooves 1026 may be determined by a desired separation between optical waveguides 922, 934. For example, the optical waveguides 922, 934 may be part of a bundle of waveguides (e.g., channel waveguides disposed on flexible cladding) having a fixed pitch. The pacing of the V-grooves 1026 may correspond to this pitch.

It should be understood that the embodiments shown in FIGS. 9 and 10 may be extended to any number of sensing facets and sensor optical waveguides on an input and/or output side. An example of an embodiment of an optical housing 1102 with two sensor facets is shown in the schematic diagram of FIG. 11. The optical housing 1102 may be configured to either receive or transmit light via input/output surface 1115. A first facet 1112 on the input/output surface 1115 is optically coupled to a first optical waveguide 1122. The first facet 1112 and first optical waveguide 1122 may be configured as optical receivers and/or optical transmitters.

The first facet 1112 is aligned with an alignment axis 1106. The housing 1102 is configured to rotate about the alignment axis 1106. A second housing (not shown) that has an input/output surface facing input/output surface 1115 of the first housing 1102 will have a corresponding first facet also aligned with the alignment axis 1106. This alignment of facets along the alignment axis 1106 ensures an optical coupling efficiency between the housings remains substantially the same through a range of movement of the housings.

The housing 1102 includes sensor facets 1132, 1142 on the input/output surface 1115. The sensor facets 1132, 1142 may be optically coupled to sensor optical waveguides 1134, 1144, respectively. In another embodiment, light from the first optical waveguide 1122 may be split and redirected to the sensor facets 1132, 1142. The sensor facets 1132, 1142 and sensor optical waveguides 1134, 1144 may be configured as optical receivers and/or optical transmitters. The sensor facets 1132, 1142 are aligned with an offset axes 1136, 1146 that are spaced apart from the alignment axis 1106.

A corresponding facet of a mating housing, generally indicated by circle 1138, will be offset from the sensor facet 1142 by a first rotation angle 1140, and from sensor facet 1132 by a second rotation angle 1141. Light will be transmitted between the corresponding facet 1138 and one of the other facets 1132, 1142 at two rotational orientations, and may be partially or fully blocked elsewhere. In this way, an optical receiving element coupled to either sensor facets 1132, 1142 or corresponding facet 1138 can detect two distinct rotational orientations. A receiving element may be able to distinguish between the two facets 1132, 1142 by using different light wavelengths (e.g., where the facets 1132, 1142 transmit separate beams of light), color filters, polarizers, etc.

The housing 1102 may have facilities for determining relative rotation between the optical housing 1102 and a corresponding housing over a wider range. As indicated by optional regions 1150, 1152, a transmitting or receiving housing may have one or more optical cavities separate from the first facet 1112 that covers a relatively large rotational region, e.g., a sector of surface 1115. For example, facets 1132, 1142 could be expanded to cover the cavities in corresponding regions 1150, 1152. The cavities could be coated with a reflective material such that corresponding facet 1138 will be illuminated via anywhere in region 1152, and be illuminated anywhere in region 1150. The illumination may be substantially weaker away from where the light enters the housing, e.g., near offset axes 1136 and 1146, but still detectable. A similar effect may be seen if light is transmitted from corresponding facet 1138 into regions 1150, 1152. As noted before, different characteristics of light (e.g., wavelength) could be used to distinguish between which cavities are being sensed by a particular sensing element.

It will be understood that active optoelectronic devices (e.g., lasers, LEDs, photo detectors, etc.) may be used in place of the passive optical components shown in FIGS. 9-11. Photodetectors could also be in the form of a pixel array such as in a charge-coupled detector (CCD) array, in which image processing techniques could be used to determine relative position. In such a case, electrical conductors may be used in place of optical waveguides to carry signals in or out of the optical housings. A hybrid approach may utilize both passive optical and active optoelectronic devices at the facets. An example of a hybrid optical position sensing housing 1160 according to an example embodiment is shown in FIG. 11A. An input/output surface 1161 of the housing includes a centrally-located facet 1162 that is optically coupled to an optical waveguide 1164, e.g., as described in similar embodiments elsewhere herein. A plurality of electrical photo detectors 1166 are arrayed concentrically around the facet 1162, and are coupled to one or more electrical conductors 1168. The housing 1160 may be paired with a light transmitting housing such as shown in FIG. 9, with at least two facets 912, 932 and at least one optical waveguide 922 providing light to the facets. The light from the off-center facet 932 will illuminate one or two of the photo detectors 1166 of housing 1160, thereby indicating relative location. An analogous embodiment may replace the photo-detectors 1166 with light transmitters such as lasers or LEDs. In some embodiments, each light transmitter may have different characteristics (e.g., wavelength) such that light received at an offset facet (e.g., facet 936 in FIG. 9) may be used to determining position by the characteristics of light received at the offset facet. In other embodiments, a counter may be used to detect location, e.g., counting signal peaks/pulses that occur after moving from a reference orientation. Or such a counter may be used without a reference orientation, e.g., to measure rotational velocity. In any of these embodiments utilizing off-axis facets, central facets on the alignment axis (e.g., facet 912 in FIG. 9) may be optional, and only non-centrally aligned facets may be used.

In the embodiments described above, housings are configured so as to transmit light between each other while facilitating relative rotation. Same or similar housings may also be used in applications where the housings are held in alignment while being allowed to translate linearly relative to one another. In reference now to FIG. 12, a cross-section view shows a telescoping optical assembly 1200 according to an example embodiment. The optical assembly 1200 includes first and second housings 1202, 1203 enclosed in first and second sliding members 1204, 1205. The first and second housings 1202, 1203 are at least part of the optical coupling assembly, and the illustrated sliding members 1204, 1205 may be optional.

The first sliding member 1204 includes a narrowed end 1204a that is disposed in an end 1205a of the second sliding member 1205 so that the sliding members 1204, 1205 are at least capable of translating relative to one another along an alignment axis 1206, as indicated by arrow 1207. This also causes the first and second housings 1202, 1203 to be translated relative to one another. The first and second housings 1202, 1203 can send and/or receive light to/from each other via opposing facets on input/output surfaces 1212, 1213 through a range of linear translation. The light may be transmitted with minimal or zero divergence along the light propagating direction (along axis 1206), such that optical coupling efficiency between the first and second housings 1202, 1203 remains substantially the same through a range of movement therebetween.

It should be noted that the alignment axis 1206 is shown as generally concentric with the first and second housings 1202, 1203. However, it is not necessary to have concentric alignment between first and second housings 1202, 1203 to maintain alignment over a translation distance, e.g., stroke length. For example, the centers of the first and second housings 1202, 1203 may be significantly offset from one another so long as respective input and output facets on the housings 1202, 1203 are aligned along a light propagation direction. However, the illustrated telescoping optical assembly 1200 may also be configured to facilitate relative rotation as shown and described, e.g., in FIGS. 1-3. In such a case, it may be desirable to align the centers of the housings 1202, 1203 (e.g., where input/output facets may be located) along a rotation axis that corresponds to the light propagation direction.

The first and second housings 1202, 1203 are separated by a variable gap region 1210. The gap region 1210 may be filled with air, or by fluid, gel, or other material that matches refractive indexes of light transmitting/receiving surfaces of the first and second housings 1202, 1203. The first and second sliding members 1204, 1205 may have provisions (e.g., ports) to allow liquids or gases to enter or leave the gap region 1210. In other configurations, the gap region 1210 may be sealed filled with a compressible fluid (e.g., air) or contain a vacuum. Generally, the first and second housings 1202, 1203 couple light between a first optical waveguide 1222 and a second optical waveguide 1223. For purposes of this discussion, the coupling of light will be described as light being received via the first optical waveguide 1222 and being sent to the second optical waveguide 1223. It will be understood that the optical assembly 1200 may transmit of light in either direction, and discussion of a particular transmission direction is for purposes of convenience and not of limitation.

The first and second optical waveguides 1222, 1223 may be any combination of optic fibers, polymer waveguides, or other optical carriers known in the art. The first optical waveguide 1222 is received in and permanently attached to a first attachment area 1224 of the first housing 1202. The first optical waveguide 1222 extends outside the first housing 1202 and receives and/or transmits light that is input to and/or output from the optical assembly 1200. The second optical waveguide 1223 is attached to a second attachment area 1225 and extends outside the second housing 1203. The second optical waveguide 1223 is configured receive and/or transmit light from/to the telescoping optical assembly 1200.

One or both of the first and second housings 1202, 1203 may be configured as shown and described for first and second housings 102, 103 shown in FIG. 6. For example, the first and second housings 1202, 1203 may utilize attachment areas 1224, 1225 configured to permanently attach optical waveguides 1222, 1223 that extends outside the housings 1202, 1203. The attachment areas 1224, 1225 may include facets that optically couple the optical waveguides 1222, 1223 to the housings 1202, 1203. The first and second housings 1202, 1203 include input/output surfaces 1212, 1213 at non-zero angle to the facets. Light redirecting members of first and second housings 1202, 1203 are optically coupled to change a direction and divergence of light between the facets and the input/output surfaces 1212, 1213 such that an illumination area of the light at the facets is smaller than an illumination area at the first input/output surfaces 1212, 1213.

The telescoping optical assembly 1200 may be configured to sense a distance between first and second housings 1202, 1203. For example, if light exiting from one of the input/output surfaces 1212, 1213 is an expanding beam, the intensity of light reaching a facet of the other of the surfaces 1212, 1213 will depend on how far away the surfaces 1212, 1213 are from each other. In FIG. 13, a cross section diagram shows a telescoping optical assembly 1300 that can sense separation distances according to example embodiments.

The optical assembly 1300 includes first and second housings 1302, 1303 enclosed in first and second sliding members 1304, 1305. The first housing 1302 and first sliding member 1304 are shown in two locations, as indicated by distances D1 and D2 from the second housing 1303. The first and second sliding members 1304, 1305 are at least capable of translating relative to one another along an alignment axis (not shown), causing the first and second housings 1302, 1303 to be translated relative to one another. The first and second housings 1302, 1303 can send and/or receive light to/from each other via opposing facets on input/output surfaces 1312, 1313 through a range of linear translation.

The first housing 1302 has two attachment areas 1324a-b, as does the second housing 1303, with attachment areas 1325a-b. The attachment areas 1324a-b, 1325a-b may be coupled to optical waveguides (not shown) either straight in or at a non-zero angle relative to the alignment axis, as described elsewhere herein. Alternatively, single attachment areas may be used on the housings 1302, 1303 and multiple light beams may be obtained using a splitter (e.g., prism). In the event optoelectronic devices are used for transmission or receiving of signals between housings 1302, 1303, one or more of the attachment areas 1324a-b, 1325a-b may be configured to attach electrical conductors.

In this example, the second housing 1303 is configured as an optical transmitter, and the first housing 1302 is configured as an optical receiver. Light received from attachment areas 1325a-b exits respectively from facets 1313a-b on output surface 1313, as indicated by light beams 1330a-b. The light exiting from the facets 1313a-b is received at facets 1312a-b respectively on the input surface 1312 of the first housing 1302. The facets 1312a-b, 1313a-b may be internally coupled to optical paths (e.g., light redirecting members) and/or to optoelectronic components.

The light 1330a exiting facet 1313a has a positive divergence, e.g., it expands as it propagates towards facet 1312a. The light 1330b exiting facet 1313b is collimated, thus it does not significantly expand as it propagates towards facet 1312b, e.g., it has a zero divergence or nearly so. In location D1, a larger portion of beam 1330a is incident on the facet 1312a than is incident on the same facet 1312a when in location D2. As such, by detecting differences in optical power received at facet 1312a, a distance between housings 1302 and 1303 can be detected.

The amount of light beam 1330b incident on facet 1312b does not vary significantly between the two locations D1, D2 of housing 1302. As such, the use of the collimated light beam 1330b can ensure consistent delivery of optical power, and may be more efficient in some cases than the expanded beam. A telescoping optical coupler 1300 may use any combination of expanding, collimated, and focused beams. In some embodiments, two beams of different divergence may be co-located, e.g., exiting a single facet or from two closely located facets. For example, if beams 1330a, 1330b were collocated, they would be shown in the figure superimposed on one another. In such a case, the beams 1330a, 1330b could have different characteristics (e.g., polarization, wavelength) that allows discerning between the beams at one or more receiving facets of the first housing 1302. The embodiment shown in FIG. 13 may also be used to detect a rotation in combination with separation distance, e.g., using the existing facets 1312a-b, 1313a-b either alone or in combination with features as described in FIGS. 9-11A.

In reference now to FIG. 14, a schematic diagram illustrates an optical connector 1400 according to an example embodiment. The optical connector 1400 includes first and second optical members 1402, 1403. The first optical member includes a first attachment area 1424 configured to permanently attach a first optical waveguide 1422 that extends along a first plane 1406 outside of the first optical member 1402. In this context, extending along the plane 1406 may refer to lying on or near any plane that is substantially parallel to plane 1406. For example, plane 1406 may correspond to a major surface of a circuit board or other structure 1430 to which the optical connector 1400 is attached. The first optical waveguide 1422 is coupled to an optical transmitter 1426, e.g., a laser diode or LED.

The first attachment area 1424 includes a first facet 1412 that optically couples light from the first optical waveguide 1422 to the first optical member 1402. The first optical member includes a first curved reflector 1408 having a first focal region 1416 proximate the first facet 1412. A lens 1414 may be provided proximate the first facet 1412, or integrated into the first facet 1412. The lens 1414 may be a conventional convex/concave surface lens, GRIN lens, etc. The first curved reflector 1408 reflects the light in a direction normal to the first plane 1406. The first curved reflector 1408 may have a shape (e.g., parabolic, toroidal) that causes an aberration in the reflected light, such as coma. The second optical member 1403 is coupled (at least optically, and possibly physically) to the first optical member 1402. The second optical member 1403 includes a second curved reflector 1409 having a second focal point 1417. The second curved reflector 1409 receives the reflected light from the first curved reflector 1408 and re-reflects the light in a second direction parallel to the first plane 1406 and towards the second focal point 1417. The second curved reflector 1409 may have a shape (e.g., parabolic, toroidal) at least partially corrects the aberration in the reflected light caused by the first curved reflector 1408.

A second attachment area 1425 is configured to permanently attach a second optical waveguide 1423 that extends parallel to the first plane 1406 and outside of the second optical member 1403. The second attachment area 1425 includes a second facet 1413 proximate the second focal point 1417 that optically couples the second optical waveguide 1423 to the second optical member 1403. A lens 1415 may be provided proximate the second facet 1413, or integrated into the second facet 1413. The lens 1415 may be a conventional convex/concave surface lens, GRIN lens, etc. The second optical waveguide 1423 is coupled to an optical receiver 1427, e.g., a photo detector, photovoltaic cell, etc.

The first and second optical waveguides 1422, 1423 may include optical fibers and/or a channel waveguides fabricated from at least one of polymers, silicon, silicon dioxide, or silicon oxynitride. As shown in this view, the first and second optical waveguides 1422, 1423 are aligned with one another, each propagating transmitted light in a direction opposite the other. The illustrated optical connector 1400 may include a plurality of first and second optical waveguides 1422, 1423, e.g., arrays of waveguides lined up next to illustrated optical waveguides 1422, 1423 along an axis normal to the page.

The first and second optical members 1402, 1403 may be fabricated separately and joined together (e.g., bonding, fastening) to form a unitary structure, or be provided as separate parts that are assembled together with the circuit board 1430. The first and second optical members 1402, 1403 may be part of a unitary structure that is formed from a single process, e.g., injection molding, layer deposition, 3D printing, etc. An example of a unitary optical connector 1500 according to an example embodiment is shown in FIG. 15. The unitary optical connector 1500 may have features similar to those shown and described in FIG. 14. The optical connector 1500 has a structure that at least forms curved reflectors 1508, 1509, the structure being formed from a single process, e.g., injection molding, layer deposition, 3D printing, etc. The unitary optical connector 1500 may include a single attachment area 1502 configured to receive and permanently attach optical waveguides 1504, 1506 that is formed in the same process. Optionally, multiple attachment areas may be formed in the same process, similar to attachment areas 1424, 1425 shown in FIG. 14.

In FIG. 16, a cross-sectional view shows an optical connector 1600 according to another example embodiment. The optical connector 1600 includes first and second optical members 1602, 1603. The first and second optical members 1602, 1603 may be configured with features similar to the embodiment shown in FIG. 14, including curved reflectors 1608, 1609, attachment areas, facets, lenses, and may be coupled to optical receivers and transmitters via first and second optical waveguides 1622, 1623. In this example embodiment, the first and second waveguides 1622, 1623 are aligned with one another, both propagating transmitted light in a common direction, e.g., either to the left or to the right of the figure. The first and second curved reflectors 1608, 1609 transmit light through a void 1629 in a circuit board or other support member 1630.

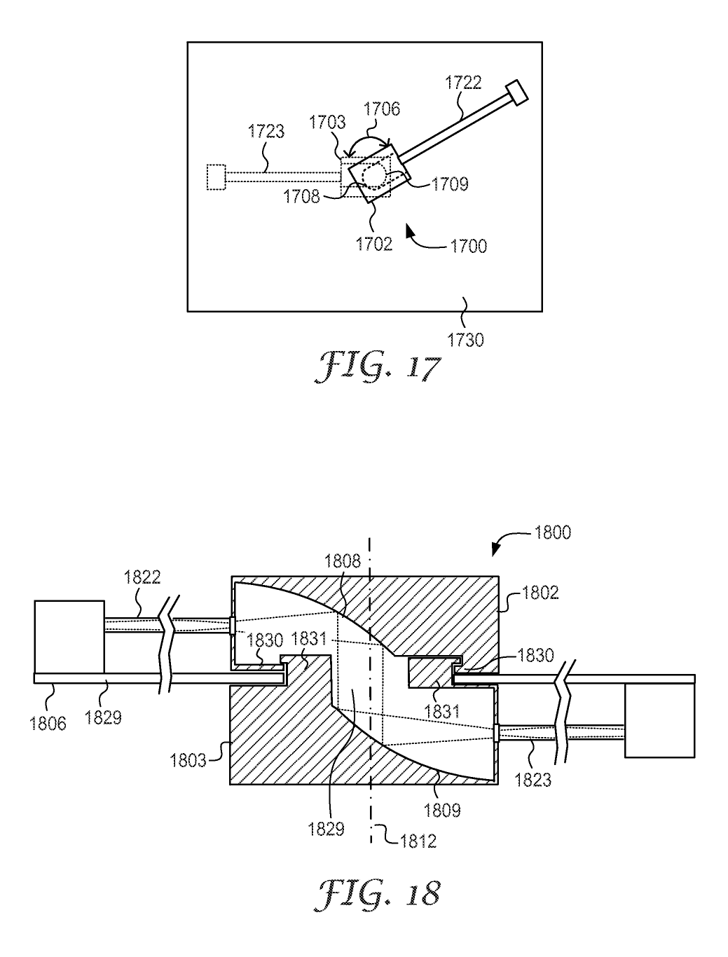

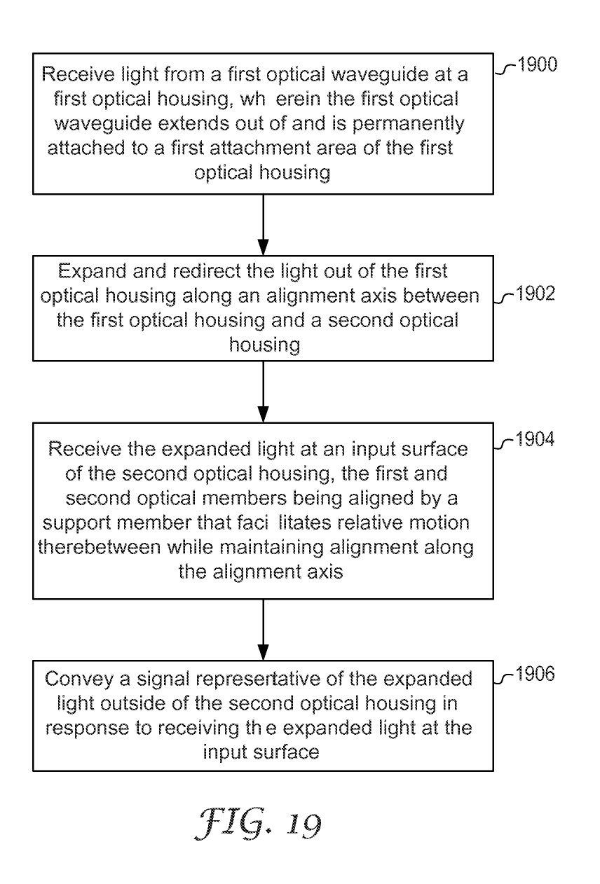

In another arrangement, one or both of the first and second waveguides 1622, 1623 may be oriented so as not to be aligned with one another, e.g., such that at least one is not parallel to the plane of the drawing page. In such a case, the first optical waveguide 1622 propagates light at an angle relative to a propagation direction of the second optical carrier 1623. An example an optical connector 1700 that facilitates angled through-plane coupling according to another example embodiment is shown in FIG. 17. The optical connector 1700 includes first and second optical members 1702, 1703. The first and second optical members 1702, 1703 may be configured with features similar to the embodiment shown in FIG. 14, including curved reflectors 1708, 1709, attachment areas, facets, lenses, and may be coupled to optical receivers and transmitters via first and second optical waveguides 1722, 1723.

In this example embodiment, first and second waveguides 1722, 1723 are disposed along a plane of a circuit board or other structural member 1730, but are not otherwise aligned with one another. In such a case, the first optical waveguide 1722 propagates light at an angle 1706 relative to a propagation direction of the second optical waveguide 1723. The angle 1706 may be fixed, e.g., by having fixed mating features between the first and second optical members 1702, 1703. The angle 1706 may be variable, either set during assembly or variable during use. An example of an optical connector 1800 having a variable rotation angle according to an example embodiment is shown in the cross-sectional diagram of FIG. 18.

The optical connector 1800 includes first and second optical members 1802, 1803. The first and second optical members 1802, 1803 may be configured with features similar to the embodiment shown in FIG. 14, including curved reflectors 1808, 1809, attachment areas, facets, lenses, and may be coupled to optical receivers and transmitters via first and second optical waveguides 1822, 1823. First and second optical members 1802, 1803 include respective first and second mating features 1830 and 1831 that facilitate relative rotation between the first and second optical members about an axis 1812 normal to a plane 1806, which in this case is a major surface of a circuit board or other structural member 1829. Depending on a shape (e.g., spherical, parabolic, toroidal) of the curved surfaces 1808, 1809, a wide range of angles around axis 1812 may be accommodated with minimal loss of optical coupling efficiency between first and second optical waveguides 1822, 1823.

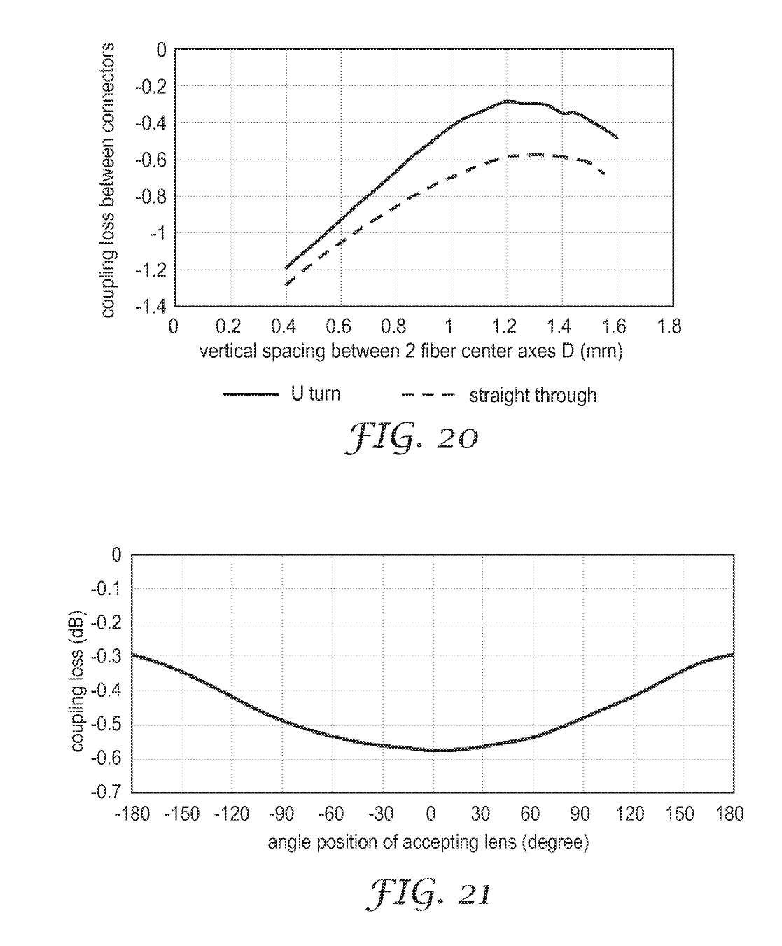

In FIG. 20, a graph showing how the parabolic reflectors in the configuration shown in FIGS. 14 and 15 (e.g., “U-turn”) have lower optical coupling loss than parabolic connectors configured as in FIG. 16 (e.g., “straight through”). This is believed to be the result of at least partial compensation of aberrations from the first reflection as a result of the second reflection. This effect also facilitates detecting an angle of rotation and/or rate of rotation of optical members configured as in FIGS. 17 and 18 by detecting changes in optical intensity. An example of how a rotation angle between parabolic reflectors may be detected is shown in the graph of FIG. 21. The graph in FIG. 21 shows coupling loss versus rotation angle between two optical members as in FIGS. 17 and 18 that utilize parabolic reflectors. The low point on the curve is a straight-through configuration as seen in FIG. 16, and the high point is a U-turn configuration as shown in FIGS. 14 and 15. An optical receiver can detect variations, e.g., in intensity of received light, caused by the relative rotation of optical members, and use these variations to detect/estimate rotation angle.

In FIG. 19, a flowchart illustrates a method according to an example embodiment. The method involves receiving 1900 light from a first optical waveguide at a first optical housing. The first optical waveguide extends out of and is permanently attached to a first attachment area of the first optical housing. The method further involves expanding and redirecting 1902 the light out of the first optical housing along an alignment axis between the first optical housing and a second optical housing. The expanded light is received 1904 at an input surface of the second optical housing. The first and second optical members are aligned by a support member that facilitates relative motion therebetween while maintaining alignment along the alignment axis. A signal representative of the expanded light is conveyed 1906 outside of the second optical housing in response to receiving the expanded light at the input surface.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on”, “connected to,” “coupled with”, or “in contact with”, or “adjacent to” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as begin “directly on,” “directly connected to,” “directly coupled with,” or “directly in contact with” another element, there are no intervening elements, components or layers for example.

The following are an exemplary list of the embodiments of the present disclosure:

Item 1 is an optical assembly comprising:

first and second housings configured to move relative to each other, the first housing comprising: an attachment area configured to permanently attach an optical waveguide that extends outside the first housing, the attachment area comprising a facet that optically couples the optical waveguide to the first housing; a first input/output surface at a non-zero angle to the facet; and a light redirecting member optically coupled to change a direction and divergence of light between the facet and the first input/output surface such that a first illumination area of the light at the facet is smaller than a second illumination area at the first input/output surface; and

wherein the second housing comprises: a second input/output surface facing and optically coupled to the first input/output surface, the first and second input/output surfaces maintaining an alignment along a light propagation direction therebetween through a range of motion between the first and second housings; and a transmission path configured to convey, outside the second housing, signals optically received or transmitted via the second input/output surface.

Item 2 is the optical assembly of item 1, wherein the first and second housings are configured to move linearly relative to each other along the light propagation direction, such than a linear movement changes a separation between the first and second input/output surfaces along the light propagation direction.

Item 3 is the optical assembly of item 1, wherein the first and second housings are configured to rotate relative to each other around the light propagation direction, such than a rotation does not change a separation between the first and second input/output surfaces along the light propagation direction.

Item 4 is the optical assembly of item 1, wherein the first and second housings are configured to rotate and translate relative to each other around and along the light propagation direction.

Item 5 is the optical assembly of items 1-4, wherein a portion of light propagating between the first and second input/output surfaces is collimated.

Item 6 is the optical assembly of item 5, wherein the portion of light propagating between the first and second input/output surfaces is collimated by the light redirecting member.

Item 7 is the optical assembly of items 1-6, wherein optical coupling efficiency between the facet and the transmission path remains substantially the same through a range of movement of the first and second housings.

Item 8 is the optical assembly of items 1-7, wherein the transmission path of the second housing comprises:

a second attachment area configured to permanently attach a second optical waveguide that extends outside the second housing, the attachment area comprising a second facet that optically couples the optical waveguide to the second housing, the second facet oriented at a second non-zero angle to the second input/output surface; and

a second light redirecting member optically coupled to change a second direction and second divergence of light between the second facet and the second input/output surface such that a third illumination area of the light at the second facet is smaller than a fourth illumination area at the second input/output surface.

Item 9 is the optical assembly of item 8, wherein the first and second housings comprise duplicate parts.

Item 10 is the optical assembly of items 8-9, wherein the first and second housings are symmetrical about a plane that is normal to the light propagation direction.

Item 11 is the optical assembly of items 1-7, wherein the transmission path of the second housing comprises an optoelectronic transducer that converts between light and electronic signals.

Item 12 is the optical assembly of item 11, wherein the optoelectronic transducer comprises a photodiode.

Item 13 is the optical assembly of item 11, wherein the optoelectronic transducer comprises a laser or light-emitting diode.

Item 14 is the optical assembly of items 1-13, wherein the light redirecting member comprises a curved reflecting surface.

Item 15 is the optical assembly of items 1-14, wherein the optical waveguide comprises a channel waveguide fabricated from at least one of polymers, silicon, silicon dioxide, or silicon oxynitride.

Item 16 is the optical assembly of items 1-15, wherein the first housing further comprises a second transmission path configured to convey second signals optically received from or transmitted to the first housing, the second signals used to determine a relative orientation between the first and second housings, and wherein the second housing further comprises a third transmission path configured to convey the second signals outside of the second housing.

Item 17 is the optical assembly of item 16, wherein the second transmission path comprises a second attachment area configured to permanently attach a second optical waveguide that extends outside the first housing, the second attachment area comprising a second facet that optically couples the second optical waveguide to the first housing, the light redirecting member optically coupled to change a second direction and second divergence of light between the second facet and the first input/output surface.

Item 18 is the optical assembly of item 16, wherein the second transmission path comprises a splitter that splits light received from the optical waveguide and directs the split light to the second transmission path.

Item 19 is the optical assembly of items 16-18, wherein the second transmission path comprises a sensor facet on the first input/output surface, the sensor facet spaced away from the alignment axis.

Item 20 is the optical assembly of item 16-19, wherein at least one of the first and second transmission paths comprises a plurality of photodetectors.

Item 21 is the optical assembly of item 20, wherein the plurality of photo detectors comprises at least one charge coupled detector array.

Item 22 is a method comprising:

receiving light from a first optical waveguide at a first optical housing, wherein the first optical waveguide extends out of and is permanently attached to a first attachment area of the first optical housing;

expanding and redirecting the light out of the first optical housing along an alignment axis between the first optical housing and a second optical housing;

receiving the expanded light at an input surface of the second optical housing, the first and second optical members being aligned by a support member that facilitates relative motion therebetween while maintaining alignment along the alignment axis; and

conveying a signal representative of the expanded light to be outside of the second optical housing in response to receiving the expanded light at the input surface.

Item 23 is the method of item 22, wherein expanding the light out of the first optical housing comprises changing a divergence of light between the first optical waveguide and the output surface such that a first illumination area of the light at the output surface is larger than a second illumination area at the first optical waveguide.

Item 24 is the method of items 22-23, wherein expanding the light out of the first optical housing comprises collimating the light.

Item 25 is the method of items 22-24, wherein the first and second optical housings are configured to move linearly relative to each other along the alignment axis, such than a linear movement changes a separation between the first and second input/output surfaces along the alignment axis.

Item 26 is the method of items 22-25, wherein the first and second optical housings are configured to rotate relative to each other around the alignment axis, such than a rotation does not change a separation between the first and second input/output surfaces along the alignment axis.

Item 27 is the method of items 22-26, wherein an optical coupling efficiency between the first optical waveguide and a transmission path that receives the expanded light remains substantially the same through a range of movement of the first and second optical housings.

Item 28 is the method of items 22-27, wherein conveying the signal representative of the expanded light outside of the second optical housing comprises redirecting and focusing the expanded light to a second optical waveguide that extends out of and is permanently attached to a second attachment area of the second optical housing.

Item 29 is the method of items 22-27, wherein conveying the signal representative of the expanded light outside of the second optical housing comprises converting the expanded light to an electronic signal.

Item 30 is the method of items 22-29, wherein expanding and redirecting the light out of the first optical housing comprises reflecting the light off of a curved surface.

Item 31 is the method of item 30, wherein the curved surface comprises a parabolic surface.

Item 32 is the method of items 22-31, further comprising:

propagating a second light beam out of the first optical housing parallel to the alignment axis;

receiving at least part of the second light beam at the second optical housing; and

determining a relative orientation between the first and second optical housings based on receiving the at least part of the second light beam.

Item 33 is the method of item 32, wherein the second light beam is spaced apart from the expanded light.

Item 34 is the method of items 32-33, further comprising:

receiving the second light beam from a second optical waveguide at the first optical housing, wherein the second optical waveguide extends out of and is permanently attached to a second attachment area of the first optical housing; and

expanding and redirecting the second light beam out of the first optical housing parallel to the alignment axis.

Item 35 is the method of items 33-34, further comprising:

splitting the light from the first optical waveguide to form the second light beam; and

expanding and redirecting the second light beam out of the first optical housing along the alignment axis.

Item 36 is the method of items 33-35, wherein determining the relative orientation comprises determining a relative rotation.

Item 37 is the method of item 32-36, wherein determining the relative orientation comprises determining a separation distance between the first and second optical housings.

Item 38 is the method of item 37, wherein the second light beam is co-located with the expanded light, and wherein the second light beam has different optical characteristics from the expanded light.

Item 39 is the method of item 38, wherein the different optical characteristics comprise at least one of wavelength and polarization.

Item 40 is the method of item 38-39, wherein the second light beam has a larger divergence than the expanded light, and wherein determining the relative orientation comprises sensing the second light beam at a second optical receiver that is spaced apart from an optical receiver that detects an intensity of the expanded light.

Item 41 is an optical connector comprising:

a first optical member comprising:
a first attachment area configured to permanently attach a first optical waveguide that extends along a first plane outside of the first optical member, the first attachment area comprising a first facet that optically couples light from the first optical waveguide to the first optical member; and
a first curved reflector having a first focal region proximate the first facet, the first curved reflector reflecting the light in a first direction normal to the first plane; and

a second optical member coupled to the first optical member, the second optical member comprising:
a second curved reflector having a second focal region, the second curved reflector receiving the reflected light and re-reflecting the light at second direction parallel to the first plane and towards the second focal region; and
a second attachment area configured to permanently attach a second optical waveguide that extends parallel to the first plane outside of the second optical member, the second attachment area comprising a second facet proximate the second focal region that optically couples the second optical waveguide to the second optical member.

Item 42 is the optical connector of item 41, wherein the first curved reflector causes an aberration in the reflected light, and wherein the second curved reflector at least partially corrects the aberration in the re-reflected light.

Item 43 is the optical connector of items 41-42, wherein the first and second curved reflectors comprise parabolic reflectors.

Item 44 is the optical connector of items 41-43, wherein the first and second optical members are parts of a unitary structure.

Item 45 is the optical connector of items 41-43, wherein the first and second optical members are separable.

Item 46 is the optical connector of item 41-43, wherein the first and second optical members comprise mating features that facilitate relative rotation between the first and second optical members about an axis normal to the first plane.

Item 47 is the optical connector of items 41-46, wherein the first optical member further comprises a lens that expands the light from the first optical waveguide to the first curved reflector.

Item 47a is the optical connector of item 47, wherein relative rotation between the first and second optical members about the axis normal to the first plane causes a change in optical coupling efficiency between the first and second optical members, the change in optical coupling efficiency used to detect an angle of the relative rotation.

Item 48 is the optical connector of item 47, wherein the lens comprises a gradient-index (GRIN) lens.

Item 49 is the optical connector of items 41-48, wherein the second optical member further comprises a lens that focuses the light to the second optical waveguide.

Item 50 is the optical connector of item 41-49, wherein at least one of the first and second optical waveguides comprise an optical fiber.

Item 51 is the optical connector of items 41-50, wherein at least one of the first and second optical waveguides comprise a channel waveguide fabricated from at least one of polymers, silicon, silicon dioxide, or silicon oxynitride.

Item 52 is the optical connector of items 41-51, wherein the first and second optical waveguides are aligned with one another, each propagating transmitted light in a direction opposite the other.

Item 53 is the optical connector of items 41, and 43-51, wherein the first and second optical waveguides are aligned with one another, both propagating transmitted light in a common direction.

Item 54 is the optical connector of item 41 and 43-51, wherein the first and second optical waveguides are not aligned with one another, the first optical carrier propagating light at an angle to a propagation direction of the second optical waveguide.

Item 55 is a method comprising:

receiving light at a first optical member via a first facet from a first optical waveguide that extends along a first plane outside of the first optical member, the waveguide permanently attached to the first optical member;

reflecting the light in a first direction normal to the first plane via a first curved reflector of the first optical member; and

receiving the reflected light at a second curved reflector of a second optical member, the second optical member being coupled to the first optical member, the second curved reflector re-reflecting the light at second direction parallel to the first plane and towards a second focal region;

receiving the re-reflected light at a second facet at the second focal region; and

directing the re-reflected light from the second facet to a second optical waveguide that extends parallel to the first plane outside of the second optical member via a second attachment area configured to permanently attach the second optical waveguide.

Item 56 is the method of item 55, wherein the first curved reflector causes an aberration in the reflected light, and wherein the second curved reflector at least partially corrects the aberration in the re-reflected light.

Item 57 is the method of item 55, wherein the first and second optical waveguides are aligned with one another, each propagating transmitted light in a direction opposite the other.

Item 58 is the method of item 55, wherein the first and second optical waveguides are aligned with one another, both propagating transmitted light in a common direction.

Item 59 is the method of item 55, wherein the first and second optical waveguides are not aligned with one another, the first optical carrier propagating light at an angle to a propagation direction of the second optical waveguide.

Item 60 is the method of item 55, wherein the first and second optical members comprise mating features that facilitate relative rotation between the first and second optical members about an axis normal to the first plane.

Item 61 is the method of item 60, wherein further comprising detecting an angle of the relative rotation based on a change in optical coupling efficiency caused by the relative rotation.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1-10. (canceled)

11. An optical assembly comprising:
first and second housings configured to move relative to each other, the first housing comprising:
a first attachment area configured to permanently attach an optical waveguide that extends outside the first housing, the first attachment area comprising a facet that optically couples the optical waveguide to the first housing;
a first input/output surface at a non-zero angle to the facet; and
a light redirecting member optically coupled to change a direction and divergence of light between the facet and the first input/output surface such that a first illumination area of the light at the facet is smaller than a second illumination area at the first input/output surface; and
wherein the second housing comprises:
a second input/output surface facing and optically coupled to the first input/output surface, the first and second input/output surfaces maintaining an alignment along a light propagation direction therebetween through a range of motion between the first and second housings; and
a transmission path configured to convey, outside the second housing, signals optically received or transmitted via the second input/output surface, the transmission path comprising a second attachment area configured to permanently attach a second optical waveguide that extends outside the second housing.

12. The optical assembly of claim 11, wherein the first and second housings are configured to move linearly relative to each other along the light propagation direction, such than a linear movement changes a separation between the first and second input/output surfaces along the light propagation direction.

13. The optical assembly of claim 11, wherein the first and second housings are configured to rotate relative to each other around the light propagation direction, such that a rotation does not change a separation between the first and second input/output surfaces along the light propagation direction.

14. The optical assembly of claim 11, wherein a portion of light propagating between the first and second input/output surfaces is collimated.

15. The optical assembly of claim 11, wherein the second attachment area comprises a second facet that optically couples the optical waveguide to the second housing, the second facet oriented at a second non-zero angle to the second input/output surface.

16. The optical assembly of claim 15, wherein the transmission path of the second housing further comprises a second light redirecting member optically coupled to change a second direction and second divergence of light between the second facet and the second input/output surface such that a third illumination area of the light at the second facet is smaller than a fourth illumination area at the second input/output surface.

17. The optical assembly of claim 16, wherein the first and second housings comprise duplicate parts.

18. The optical assembly of claim 16, where the first and second housings are symmetrical about a plane that is normal to the light propagation direction.

19. A method comprising:
receiving light from a first optical waveguide at a first optical housing, wherein the first optical waveguide extends out of and is permanently attached to a first attachment area of the first optical housing;
expanding and redirecting the light out of the first optical housing along an alignment axis between the first optical housing and a second optical housing;
receiving the expanded light at an input surface of the second optical housing, the first and second optical members being aligned by a support member that facilitates relative motion therebetween while maintaining alignment along the alignment axis; and
conveying a signal representative of the expanded light to be outside of the second optical housing in response to receiving the expanded light at the input surface.

20. The method of claim 19, wherein conveying the signal representative of the expanded light outside of the second optical housing comprises redirecting and focusing the expanded light to a second optical waveguide that extends out of and is permanently attached to a second attachment area of the second optical housing.

21. The method of claim 19, further comprising:
propagating a second light beam out of the first optical housing parallel to the alignment axis;
receiving at least part of the second light beam at the second optical housing; and
determining a relative orientation between the first and second optical housings based on receiving the at least part of the second light beam.

22. The method of claim 21, wherein determining the relative orientation comprises determining a relative rotation.

23. The method of claim 21, wherein determining the relative orientation comprises determining a separation distance between the first and second optical housings.

24. An optical connector comprising:
a first optical member comprising:
a first attachment area configured to permanently attach a first optical waveguide that extends along a first plane outside of the first optical member, the first attachment area comprising a first facet that optically couples light from the first optical waveguide to the first optical member; and
a first curved reflector having a first focal region proximate the first facet, the first curved reflector reflecting the light in a first direction normal to the first plane; and
a second optical member coupled to the first optical member, the second optical member comprising:
a second curved reflector having a second focal region, the second curved reflector receiving the reflected light and re-reflecting the light at second direction parallel to the first plane and towards the second focal region; and
a second attachment area configured to permanently attach a second optical waveguide that extends parallel to the first plane outside of the second optical member, the second attachment area comprising a second facet proximate the second focal region that optically couples the second optical waveguide to the second optical member.

25. The optical connector of claim 24, wherein the first curved reflector causes an aberration in the reflected light, and wherein the second curved reflector at least partially corrects the aberration in the re-reflected light.

26. The optical connector of claim 24, wherein the first and second optical members comprise mating features that facilitate relative rotation between the first and second optical members about an axis normal to the first plane.

27. The optical connector of claim 26, wherein relative rotation between the first and second optical members about the axis normal to the first plane causes a change in optical coupling efficiency between the first and second optical members, the change in optical coupling efficiency used to detect an angle of the relative rotation.

28. A method comprising:
receiving light at a first optical member via a first facet from a first optical waveguide that extends along a first plane outside of the first optical member, the waveguide permanently attached to the first optical member;
reflecting the light in a first direction normal to the first plane via a first curved reflector of the first optical member; and
receiving the reflected light at a second curved reflector of a second optical member, the second optical member being coupled to the first optical member, the second curved reflector re-reflecting the light at second direction parallel to the first plane and towards a second focal region;
receiving the re-reflected light at a second facet at the second focal region; and
directing the re-reflected light from the second facet to a second optical waveguide that extends parallel to the first plane outside of the second optical member via a second attachment area configured to permanently attach the second optical waveguide.

29. The method of claim 28, wherein the first curved reflector causes an aberration in the reflected light, and wherein the second curved reflector at least partially corrects the aberration in the re-reflected light.

30. The method of claim 28, wherein the first and second optical members comprise mating features that facilitate relative rotation between the first and second optical members about an axis normal to the first plane, the method further comprising detecting an angle of the relative rotation based on a change in optical coupling efficiency caused by the relative rotation.
